(19) United States
(12) Patent Application Publication
(10) Pub. No.: US 2025/0037091 A1
(43) Pub. Date: Jan. 30, 2025

(54) REPAIR INFORMATION PROVIDING APPARATUS AND REPAIR INFORMATION PROVIDING METHOD

(71) Applicant: Honda Motor Co., Ltd., Tokyo (JP)

(72) Inventors: Takayuki Ishibashi, Tokyo (JP); Takahiro Yoshii, Tokyo (JP); Shogo Shibahara, Tokyo (JP); Yudai Okabe, Tokyo (JP); Hirofumi Yabu, Tokyo (JP); Kohei Mukaihara, Tokyo (JP); Kohei Saito, Tokyo (JP)

(21) Appl. No.: 18/774,757

(22) Filed: Jul. 16, 2024

(30) Foreign Application Priority Data
Jul. 19, 2023 (JP) 2023-117233

(51) Int. Cl. G06Q 10/20

(52) U.S. Cl. CPC G06Q 10/20

(57) ABSTRACT

Repair information providing apparatus includes: processor and memory. Memory is configured to store repair information regarding repairs of product. Processor is configured to perform: acquiring repair information; and determining whether repair performed at first time point is re-repair for eliminating defect that has not been eliminated by repair performed at second time point before first time point based on repair information. Repair information includes occurrence information of defect and information of repaired component part for every repair. Processor determines that repair performed at first time point is re-repair when first target component part repaired at first 10 time point and second target component part repaired at second time point coincide with each other, or when defect content identified by occurrence information of defect in first target component part and defect content identified by occurrence information of defect in second target component part coincide with each other.

### CROSS-REFERENCE TO RELATED APPLICATION

This application is based upon and claims the benefit of priority from Japanese Patent Application No. 2023-117233 filed on Jul. 19, 2023, the content of which is incorporated herein by reference.

### BACKGROUND OF THE INVENTION

### Field of the Invention

The present invention relates to a repair information providing apparatus and a repair information providing method configured to provide information regarding repairs of a product.

### Description of the Related Art

As an apparatus of such a type, an apparatus that provides information regarding a vehicle repairing method has been conventionally known. For example, the apparatus described in JP 2005-157580 A identifies a symptom code indicating the type of a defect that is occurring in a vehicle, and extracts a plurality of corresponding work codes corresponding to the symptom code that has been identified. Then, with reference to the corresponding work code and the repair date in a repair history table in the past, a corresponding work code indicating work that has not been conducted within last six months is output as a repairing method having a higher priority.

When a defect such as a failure occurs in a product, it is preferable to correctly identify a cause of the defect and necessary measures and eliminate the defect by carrying out a one-time repair. However, when the repair has to be carried out once again, it is necessary to promptly verify the factor that has led to such a re-repair and take necessary measures. However, there are various situations that lead to the re-repair. Hence, it is difficult to accurately determine whether each repair is a re-repair. For example, as in the apparatus described in JP 2005-157580 A, it is difficult to accurately determine only from the viewpoint that different repairs have been carried out on similar symptoms.

### SUMMARY OF THE INVENTION

An aspect of the present invention is a repair information providing apparatus, including: a processor and a memory coupled to the processor. The memory is configured to store repair information regarding repairs of a product. The processor is configured to perform: acquiring the repair information; and determining whether a repair performed on the product at a first time point is a re-repair for eliminating a defect of the product that has not been eliminated by a repair performed on the product at a second time point before the first time point based on the repair information. The repair information includes occurrence information of the defect and component part information of a repaired component part for every repair of the product. The processor determines that the repair performed at the first time point is the re-repair when a first target component part repaired at the first time point and a second target component part repaired at the second time point coincide with each other, or when a defect content identified by the occurrence information of the defect in the first target component part and a defect content identified by the occurrence information of the defect in the second target component part coincide with each other.

Another aspect of the present invention is a repair information providing method, including the steps of: acquiring the repair information regarding repairs of a product; and determining whether a repair performed on the product at a first time point is a re-repair for eliminating a defect of the product that has not been eliminated by a repair performed on the product at a second time point before the first time point based on the repair information. The repair information includes occurrence information of the defect and component part information of a repaired component part for every repair of the product. The determining includes determining that the repair performed at the first time point is the re-repair when a first target component part repaired at the first time point and a second target component part repaired at the second time point coincide with each other, or when a defect content identified by the occurrence information of the defect in the first target component part and a defect content identified by the occurrence information of the defect in the second target component part coincide with each other.

### BRIEF DESCRIPTION OF THE DRAWINGS

The objects, features, and advantages of the present invention will become clearer from the following description of embodiments in relation to the attached drawings, in which:

FIG. 1 is a diagram for describing various factors that lead to a re-repair of a product;

FIG. 2 is a diagram for describing re-repair cases;

FIG. 3 is a block diagram schematically illustrating an example of an overall configuration of a repair information providing system including a repair information providing apparatus according to an embodiment of the present invention;

FIG. 4 is a diagram for describing repair information managed by the repair information providing apparatus of FIG. 3;

FIG. 5 is a diagram for describing re-repair determination by a re-repair determination unit of FIG. 3;

FIG. 6 is a diagram illustrating an example of re-repair determination results by the re-repair determination unit of FIG. 3; and

FIG. 7 is a flow chart showing an example of process executed by the repair information providing apparatus of FIG. 1.

### DETAILED DESCRIPTION OF THE INVENTION

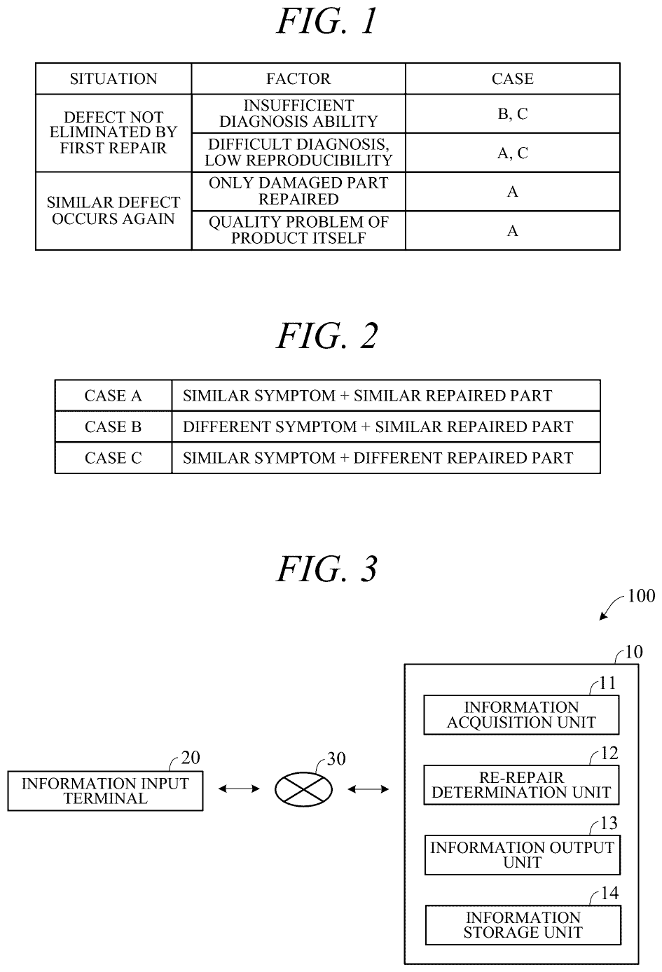

Hereinafter, embodiments of the present invention will be described with reference to FIGS. 1 to 7. A repair information providing apparatus according to an embodiment of the present invention provides information regarding repairs of a product such as a vehicle, particularly information regarding whether each repair is a re-repair. When a defect such as a failure occurs in a product, it is preferable to correctly identify a cause of the defect and necessary measures and eliminate the defect by carrying out a one-time repair. However, when the repair has to be carried out once again, it is necessary to promptly verify the factor that has led to such a re-repair and take necessary measures. FIG. 1 is a diagram for describing various factors that lead to a re-repair of a product. As illustrated in FIG. 1, the situation that leads to the re-repair is roughly divided into a case where the defect is not eliminated by the first repair and a case where the defect is once eliminated by the first repair, but a similar defect occurs again after that. As a factor in the case where the defect is not eliminated by the first repair, a person responsible for the repair is insufficient in diagnosis ability, and is not able to correctly identify the cause of the defect or necessary measures, reproducibility of the defect is low, its diagnosis is difficult in any way, or the like. As a factor in a case where the similar defect occurs again, the repair is carried out only on a damaged part, which is adversely affected (damaged) by a cause part, and in which the defect is occurring, but the repair is not carried out on the cause part that is the cause of the defect, or a quality problem is occurring in a product itself.

FIG. 2 is a diagram for describing re-repair cases or patterns. As illustrated in FIGS. 1 and 2, in a case where similar defect symptoms are occurring again or continuously at a first repair time and at a second repair time, when it is clear that a similar part should be repaired or when it is difficult to identify any other repair part, the similar part is repaired in some cases (case A). Such a repair is regarded as a re-repair for eliminating a defect that has not been eliminated by the first repair.

In a case where the defect is not eliminated by the first repair, and a defect symptom different from that of the first repair time, that is, a related defect symptom or an advanced defect symptom appears at the second repair time, a similar part is repaired again in some cases (case B). For example, when oil leakage occurs on a damper as a vehicle component part, abnormal sounds are generated in some cases, as the related defect symptom or the advanced defect symptom. Such a repair is also regarded as a re-repair. In a case where a defect is not eliminated by the first repair, a new defect symptom different from that of the first repair time appears at the second repair time, and a different part is repaired, such a case is not regarded as the re-repair.

In a case where a defect is not eliminated by the first repair and a defect symptom similar to that of the first repair time appears also at the second repair time, there is a possibility that the part that has been repaired by the first repair is not appropriate, and thus a part different from that of the first repair time is repaired in some cases (case C). Such a repair is also regarded as a re-repair.

In the present embodiment, a repair information providing apparatus is configured as follows so as to be capable of accurately determining whether each repair is a re-repair and to be capable of providing information regarding the repairs of a product, in consideration of all re-repair cases as illustrated in FIG. 2.

FIG. 3 is a block diagram schematically illustrating an example of an overall configuration of a repair information providing system 100, which includes a repair information providing apparatus (hereinafter, the apparatus) 10 according to an embodiment of the present invention. As illustrated in FIG. 3, the repair information providing system 100 includes: the apparatus 10; and an information input terminal 20, which is provided in a store or the like that repairs products such as vehicles. The information input terminal 20 may include a terminal managed by a business entity that manufactures the products such as the vehicles. The apparatus 10 and the information input terminal 20 are communicably connected with each other through a communication network 30 including a local area network (LAN) or a wide area network (WAN) such as the Internet.

The apparatus 10 includes a computer including a processor (central processing unit: CPU), a ROM, a RAM (memory), other peripheral circuits, and the like. The apparatus 10 includes an information acquisition unit 11, a re-repair determination unit 12, and an information output unit 13, which serve as functional configurations of the processor, and includes an information storage unit 14, which serves as a functional configuration of the memory. That is, the processor of the apparatus 10 functions as the information acquisition unit 11, the re-repair determination unit 12, and the information output unit 13, and the memory of the apparatus 10 functions as the information storage unit 14. The apparatus 10 may be configured as a single server apparatus, may be configured as a server apparatus of a distributed type, or may be configured as a virtual server apparatus of a distributed type provided in a cloud environment.

The information input terminal 20 includes, for example, a device connectable to the communication network 30, such as a personal computer or a tablet terminal provided in a store or the like that repairs the products such as the vehicles. Repair information and the like related to the repair of the products are input into the information input terminal 20 by a store staff or the like. The repair information that has been input into the information input terminal 20 is transmitted to the apparatus 10 through the communication network 30, and is managed.

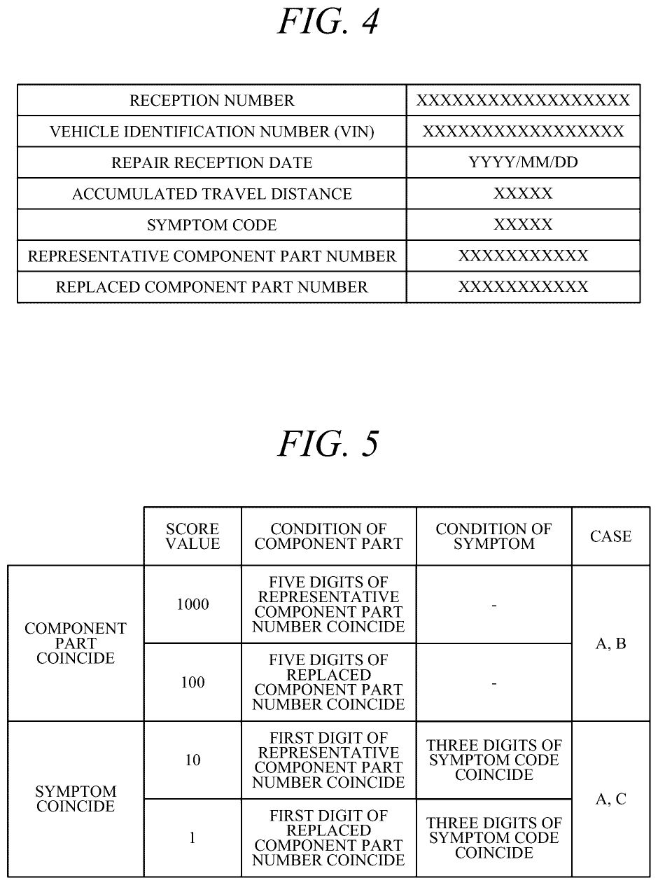

FIG. 4 is a diagram for describing the repair information. As illustrated in FIG. 4, the repair information includes an identification number (in the example of FIG. 4, a reception number) for identifying one-time repair for every repair of a product, and an identification number (in the example of FIG. 4, a vehicle identification number) for identifying the product that has been repaired. In addition, information indicating the date and time for identifying the time when the repair was carried out and a used amount of the product (in the example of FIG. 4, a repair reception date and an accumulated travel distance) is included.

The repair information further includes information for identifying a defect content (a defect symptom) that has occurred in the product (in the example of FIG. 4, a symptom code), and information for identifying a component part that has been actually repaired (in the example of FIG. 4, a representative component part number and a replaced component part number). The “representative component part” denotes a single component part that has been identified as the cause of the defect and that has been repaired. The “replaced component part” denotes a component part that has been replaced in accordance with the repair on the representative component part. There is no replaced component part in some cases, or there are a plurality of replaced component parts in some cases. The repair includes, in addition to replacement of a defective component part in which the defect has occurred with a new component part, removing the defective component part, taking some measures such as inspection, cleaning, and machining, and then attaching such a component part to the product again. The component part number includes a plurality of character strings, and one of the character strings (for example, the first one digit) identifies a mounting part or a broad classification of the component part, and some character strings (for example, the first five digits) identify the component part itself. The symptom code also includes a plurality of character strings, and some character strings (for example, the first three digits) identify the defect symptom.

The information acquisition unit 11 of the apparatus 10 acquires the repair information transmitted from the information input terminal 20. The repair information that has been acquired by the information acquisition unit 11 is stored and accumulated in the information storage unit 14.

The re-repair determination unit 12 determines whether the repair carried out on the product at a first time point is a re-repair for eliminating a defect of the product that has not been eliminated by the repair performed at a second time point, which is before the first time point, based on the repair information that has been acquired by the information acquisition unit 11. For example, when the repair information of a new repair is acquired by the information acquisition unit 11, the repair information of the repair in the past that has been carried out on an identical product is extracted from the accumulated repair information stored in the information storage unit 14, and whether the present case corresponds to a re-repair case is determined as illustrated in FIG. 2. Alternatively, the repair information of a series of repairs that has been carried out on each product is extracted from the repair information stored and accumulated in the information storage unit 14, and whether every combination of the repair information corresponds to a re-repair case as illustrated in FIG. 2 is determined.

FIG. 5 is a diagram for describing re-repair determination by the re-repair determination unit 12. The re-repair determination unit 12 first extracts the repair information of the repair carried out on the product at the first time point and the repair information of the repair carried out at the second time point, which is before the first time point, from the repair information acquired by the information acquisition unit 11 and stored in the information storage unit 14. More specifically, a combination of pieces of the repair information having an identical identification number for identifying a product (for example, the vehicle identification number) and having different repair time points or different used amounts of the product (for example, the accumulated travel distance) is extracted.

In this situation, the repair information may be extracted by limiting the period from the second time point to the first time point to a predetermined period. That is, even in the re-repair cases as illustrated in FIG. 2, the repair after the predetermined period has elapsed from the previous repair is not regarded as a re-repair in general. The predetermined period may be determined, based on a period of time (for example, half a year or the like), or may be determined, based on the used amount of the product (for example, a travel distance of 10,000 km or the like). The predetermined period of time may be determined for every component part in accordance with, for example, a service life period of each component part.

Next, as illustrated in FIG. 5, the re-repair determination unit 12 compares the representative component part number included in the extracted repair information of the first time point (the component part number of the representative component part at the first time point) with the representative component part number included in the repair information of the second time point (the component part number of the representative component part at the second time point). In addition, the replaced component part number included in the repair information of the first time point (the component part number of the replaced component part at the first time point) is compared with the replaced component part number included in the repair information of the second time point (the component part number of the replaced component part at the second time point). In a case where the first five digits of the component part numbers coincide with each other, a first target component part to be repaired at the first time point (the representative component part at the first time point or the replaced component part at the first time point) and a second target component part to be repaired at the second time point (the representative component part at the second time point or the replaced component part at the second time point) are an identical component part. This case corresponds to the case A or the case B in FIG. 2, and the repair at the first time point is determined to be a re-repair for the repair at the second time point. Note that with regard to the replaced component part, it is sufficient if any of the replaced component part at the first time point and any of the replaced component part at the second time point are an identical component part.

The re-repair determination unit 12 further compares a symptom code included in the repair information of the first time point (a symptom code at the first time point) with a symptom code included in the repair information of the second time point (a symptom code at the second time point). In a case where the first three digits of the symptom codes coincide with each other, it can be said that a similar defect symptom is occurring again or continuously at the first time point and the second time point. In addition, even though the first five digits of the component part numbers do not coincide with each other, in a case where the first one digits in the component part numbers coincide with each other, the first target component part and the second target component part are component parts having an identical mounting part or identical broad classification. Therefore, in a case where the first three digits in the symptom codes and the first one digits in the component part numbers coincide with each other, it can be said that there is a relation between the repair at the first time point and the repair at the second time point. This case corresponds to the case A or the case C in FIG. 2, and the repair at the first time point is determined to be a re-repair for the repair at the second time point. Note that with regard to the replaced component part, it is sufficient if any of the replaced component parts at the first time point and any of the replaced component parts at the second time point are component parts having an identical mounting part or identical broad classification.

A determination result by the re-repair determination unit 12 is stored in the information storage unit 14. More specifically, out of pieces of the repair information stored in the information storage unit 14, information of the number of re-repair times is given to the repair information of the second time point, and in addition, the repair information of the repair at the first time point that has been carried out as the re-repair is associated with the repair information of the second time point, and the repair information is updated.

The re-repair determination unit 12 further calculates (determines) a score value indicating a degree of possibility that the repair at the first time point is a re-repair. That is, in a case where the first five digits in the component part numbers of the representative component part at the first time point and the representative component part at the second time point coincide with each other, which means a case of the highest possibility that the repair at the first time point is the re-repair, a first score value that is the highest one (in the example of FIG. 5, 1000 points) is calculated. In a case where the first five digits in the component part numbers of the replaced component part at the first time point and the replaced component part at the second time point coincide with each other, a second score value that is the next highest one after the first score value (in the example of FIG. 5, 100 points) is calculated. In a case where the first one digits in the component part numbers and the first three digits in the symptom codes of the representative component part at the first time point and the representative component part at the second time point coincide with each other, a third score value that is the next highest one after the second score value (in the example of FIG. 5, 10 points) is calculated. In a case where the first one digits in the component part numbers and the first three digits in the symptom codes of the replaced component part at the first time point and the replaced component part at the second time point, a fourth score value that is the next highest one after the third score value (in the example of FIG. 5, one point) is calculated.

The score value that has been calculated by the re-repair determination unit 12 is stored in the information storage unit 14. More specifically, the score value that has been calculated by the re-repair determination unit 12 is given to the combination of the repair information of the first time point and the repair information of the second time point, and the repair information stored in the information storage unit 14 is updated.

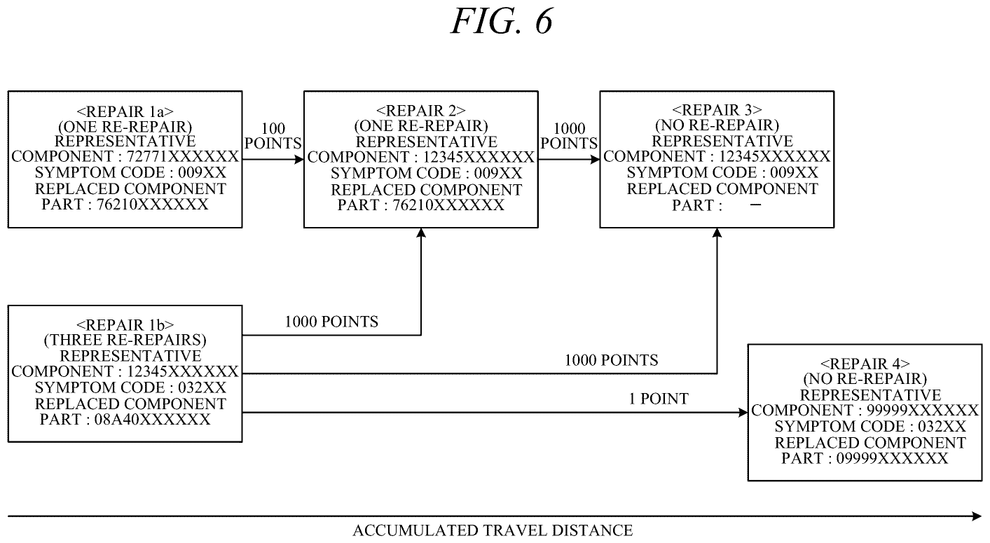

FIG. 6 is a diagram illustrating an example of re-repair determination results by the re-repair determination unit 12, and illustrates an example of a series of repairs carried out on the vehicle having the identical vehicle identification number at the timings of different accumulated travel distances. As illustrated in FIG. 6, between a repair 1a and a repair 2, the first five digits in the component part numbers of the representative component parts do not coincide with each other, but the first five digits in the component part numbers of the replaced component parts coincide with each other. Therefore, the repair 2 is determined to be the re-repair of the repair 1a, and 100 points are calculated as the score value. Among the repair 1a, a repair 3, and a repair 4, neither the first one digits in the component part numbers of the representative component parts nor the first one digits in the component part numbers of the replaced component parts coincide with one another, and it is determined that neither the repair 3 nor the repair 4 is a re-repair of the repair 1a. In this case, information indicating that the re-repair has been carried out once is given to the repair information of the repair 1a, and in addition, the repair information of the repair 2, which has been carried out as the re-repair, is associated with the repair information, and the repair information is updated.

Among the repair 1b, the repair 2, and the repair 3, the first five digits in the component part numbers of the representative component parts coincide one another, it is determined that repair 2 and the repair 3 are the re-repairs of the repair 1b, and 1000 points are calculated as the score value. Between the repair 1b and the repair 4, the first one digits in the component part numbers of the representative component parts do not coincide with each other. However, the first one digits in the component part numbers of the replaced component parts and the first three digits in the symptom codes coincide with each other, it is determined that the repair 4 is the re-repair of the repair 1b, and one point is calculated as the score value. In this case, information indicating that the re-repair has been carried out three times is given to the repair information of the repair 1b, and in addition, the repair information of the repair 2, the repair 3, and the repair 4, which have been carried out as the re-repairs, is associated with the repair information, and the repair information is updated.

Between the repair 2 and the repair 3, the first five digits in the component part numbers of the representative component parts coincide with each other, it is determined that the repair 3 is the re-repair of the repair 2, and 1000 points are calculated as the score value. Between the repair 2 and the repair 4, neither the first one digits in the component part numbers of the representative component parts nor the first one digits in the component part numbers of the replaced component parts coincide with each other, and it is determined that the repair 4 is not the re-repair of the repair 2. In this case, information indicating that the re-repair has been carried out once is given to the repair information of the repair 2, and in addition, the repair information of the repair 3, which has been carried out as the re-repair, is associated with the repair information, and the repair information is updated.

Between the repair 3 and the repair 4, neither the first one digits in the component part numbers of the representative component parts nor the first one digits in the component part numbers of the replaced component parts coincide with each other, and it is determined that the repair 4 is not the re-repair of the repair 3.

When determining that the repairs carried out at a plurality of the first time points are re-repairs for the repair carried out at the single second time point, the re-repair determination unit 12 identifies a combination of the repair at the first time point having the highest re-repair possibility and the repair at the second time point. In the example of FIG. 6, from among a combination of the repair 1b and the repair 2, a combination of the repair 1b and the repair 3, and a combination of the repair 1b and the repair 4, which have been determined to be combinations including re-repairs, the combination of the repair 1b and the repair 2 and the combination of the repair 1b and the repair 3 having the highest score value are identified as combinations having the highest re-repair possibility. In this case, information indicating that the repair 2 and the repair 3 each have the highest re-repair possibility for the repair 1b is further given to the repair information of the repair 1b, and the repair information is updated. Only the combination of the repair 1b and the repair 2 and the combination of the repair 1b and the repair 3 having the highest score value may be combinations including re-repairs.

Such a score value indicates not only the degree of possibility that the repair at the first time point is a re-repair but also a magnitude of an influence of a defect related to the re-repair on a product, and also indicates a degree of priority of a response to the defect. That is, in a case where the first five digits in the component part numbers of the representative component parts or the replaced component parts coincide with each other between the first time point and the second time point, and an identical component part is repaired again, there is a high probability that a quality problem is occurring in the product (component part) itself, and it is necessary to take measures such as a design change for the component part promptly. In this manner, in the case where the defect related to the re-repair has a large influence on the product and the priority of the response to the defect is high, a relatively high score value is calculated. On the other hand, in a case where only the first one digits in the component part numbers of the representative component parts or the replaced component parts coincide with each other between the first time point and the second time point and a different component part is repaired again, there is a high possibility that a component part that should have been treated in the first repair has not been correctly identified, and there is a low possibility that the quality problem is occurring in the component part itself. In this manner, in a case where the influence of the defect related to the re-repair on the product is relatively small and the priority of the response to the defect is relatively low, a relatively low score value is calculated.

The information output unit 13 outputs the updated repair information stored in the information storage unit 14 to the outside. For example, the updated repair information for every store where the products such as the vehicles are repaired is transmitted to the information input terminal 20, which is provided for every store. The information output unit 13 may output all or a part of the repair information stored in the information storage unit 14. For example, only the repair information of each store may be extracted and transmitted to the information input terminal 20 of each store. The information output unit 13 may output the updated repair information, whenever the information acquisition unit 11 acquires repair information of a new repair, or may output the updated repair information regularly (for example, daily, weekly, monthly, or the like). For example, whenever the repair information of the new repair is transmitted from each store to the apparatus 10, the re-repair determination is made, and the updated repair information is transmitted to the information input terminal 20 of each store. In this case, in each store, it is possible to promptly confirm whether the new repair is a re-repair for eliminating the defect that has not been eliminated by the repair in the past, and the repair in the past that has led to the re-repair. Accordingly, in each store, it becomes possible to promptly verify a factor that has led to the re-repair and take necessary measures.

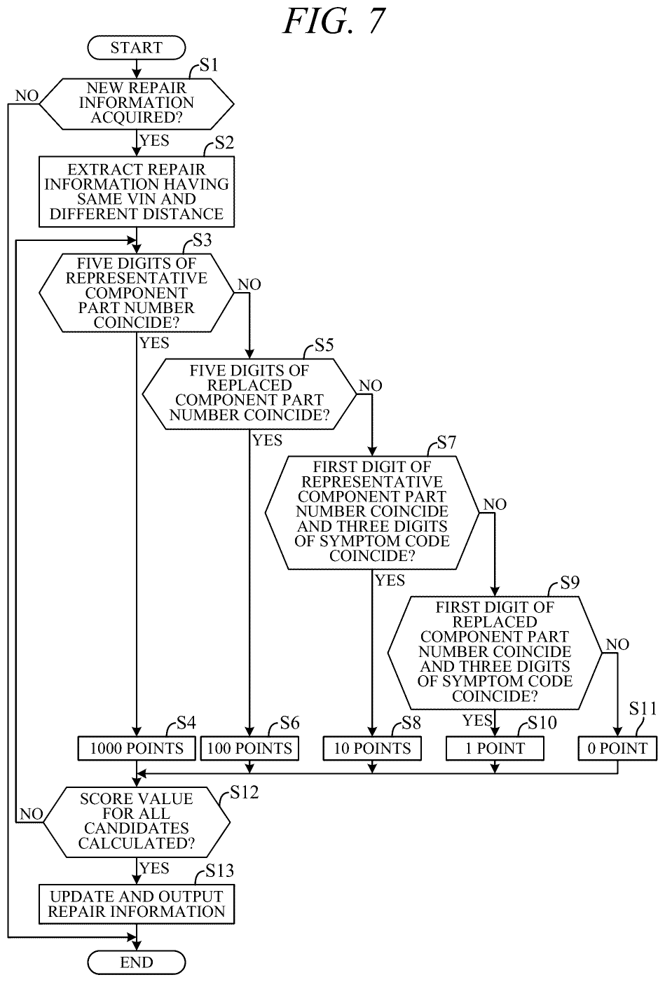

FIG. 7 is a flow chart showing an example of process executed by the apparatus 10. FIG. 7 shows an example for the case where a re-repair determination is made each time new repair information is acquired from the information input terminal 20. The process in FIG. 7 is executed repeatedly at a predetermined cycle. As shown in FIG. 7, first at S1 (S: processing step), it is determined whether new repair information has been acquired from the information input terminal 20. If affirmed at S1, the process moves to S2; if denied, the process ends. At S2, from the past repair information stored in the information storage unit 14, repair information that has the same vehicle identification number as the repair information at the first time point acquired at S1 but has a different accumulated travel distance is extracted as a candidate for the repair information at the second time point.

Then at S3, it is determined whether the first five digits of the representative component part number included in the repair information at the first time point acquired at S1 and the repair information at the second time point extracted as each candidate at S2 coincide with each other. If affirmed at S3, the process moves to S4, where a first score value (1000 points) is assigned to the combination of the repair information at the first time point and the repair information at second time point that were determined at S3, and the repair information stored in the information storage unit 14 is updated.

If denied at S3, the process moves to S5, where it is determined whether the first five digits of the replaced component part number included in the repair information at the first time point and the repair information at second time point that were determined at S3 coincide with each other. If affirmed at S5, the process moves to S6, where a second score value (100 points) is assigned to the combination of the repair information at the first time point and the repair information at the second time point that were judged at S3 and S5, and the repair information is updated.

If denied at S5, the process moves to S7, where it is determined whether the first digit of the representative component part number and the first three digits of the symptom code included in the repair information at the first time point and the repair information at the second time point that were determined at S3 and S5 coincide with each other. If affirmed at S7, the process moves to S8, where a third score value (10 points) is assigned to the combination of the repair information at the first time point and the repair information at the second time point that were determined at S3, S5, and S7, and the repair information is updated.

If denied at S7, the process moves to S9, where it is determined whether the first digit of the replaced component part number and the first three digits of the symptom code included in the repair information at the first time point and the repair information at the second time point that were determined at S3, S5, and S7 coincide with each other. If affirmed at S9, the process moves to S10, where a fourth score value (1 point) is assigned to the combination of the repair information at the first time point and the repair information at the second time point that were determined at S3, S5, S7, and S9, and the repair information is updated.

If denied at S9, the process moves to S11, where a score value (0 points) indicating that the combination is not a re-repair is assigned to the combination of the repair information at the first time point and the repair information at the second time point that were determined at S3, S5, S7, and S9, and the repair information is updated.

Then at S12, it is determined whether a score value has been calculated for all candidates for the repair information at the second time point extracted at S2. If denied at S12, the process returns to S3 to determine the next candidate. If affirmed at S12, the process moves to S13, where the updated repair information is transmitted to the information input terminal 20, and the process ends.

Thus, by making a re-repair determination considering all cases of re-repair as shown in FIGS. 2 and 5 (S3 to S11), it is possible to accurately determine whether each repair is a re-repair. Furthermore, by making a re-repair determination each time new repair information is acquired and providing the repair information (S1, S13), it is possible to promptly investigate the causes leading to the re-repair and take necessary measures.

According to the present embodiment, the following effects can be achieved.

(1) The apparatus 10 includes: the information storage unit 14, which stores repair information regarding repairs of a product; the information acquisition unit 11, which acquires the repair information; and the re-repair determination unit 12, which determines whether the repair carried out on the product at the first time point is a re-repair for eliminating a defect of the product that has not been eliminated by the repair carried out at the second time point, which is before the first time point, based on the repair information acquired by the information acquisition unit 11 (FIG. 3). The repair information includes, for every repair of the product, occurrence information of the defect of the product and information of a component part that has been repaired (FIG. 7).

In a case where the first target component part repaired at the first time point and the second target component part repaired at the second time point coincide with each other, or in a case where a defect content identified by the occurrence information of the defect in the first target component part and a defect content identified by the occurrence information of the defect in the second target component part coincide with each other, the re-repair determination unit 12 determines that the repair carried out at the first time point is a re-repair (FIGS. 2 and 5). In this manner, the re-repair determination is made, based on the repair information, in consideration of all the re-repair cases as illustrated in FIGS. 2 and 5, and thus it becomes possible to accurately determine whether each repair is a re-repair.

(2) In a case where the defect content identified by the occurrence information of the defect in the first target component part and the defect content identified by the occurrence information of the defect in the second target component part coincide with each other, the re-repair determination unit 12 determines that the repair carried out at the first time point is the re-repair, on condition that the mounting part of the first target component part and the mounting part of the second target component part in the product coincide with each other. Accordingly, it becomes possible to accurately determine whether each repair is a re-repair.

(3) The re-repair determination unit 12 further calculates a score value indicating a degree of possibility that the repair carried out at the first time point is the re-repair. The re-repair determination unit 12 calculates a score value of a case where the first target component part and the second target component part coincide with each other (the case A and the case B in FIG. 2) to be higher than a score value of a case where a defect content identified by the occurrence information of the defect in the first target component part and a defect content identified by the occurrence information of the defect in the second target component part coincide with each other (the case A and the case C in FIG. 2) (FIG. 5). In this case, it becomes possible to easily and accurately evaluate the degree of possibility that each repair is the re-repair, based on the repair information. In addition, it becomes possible to easily and accurately evaluate the magnitude of the influence of the defect related to the re-repair on the product and the degree of priority of the response to the defect.

(4) When determining that the repairs carried out at the plurality of first time points are the re-repairs for the repair carried out at the single second time point, the re-repair determination unit 12 identifies a combination of the repair carried out at the first time point having a highest possibility and the repair carried out at the second time point. In this case, for example, only a combination having the highest score value can be identified as a combination of re-repairs. In addition, a combination having a high score value has a high probability that a quality problem is occurring in a product (component part) itself, and it is necessary to take measures such as a design change in the component part promptly, so that necessary measures can be taken in an efficient manner by identifying such a re-repair.

(5) A period of time from the second time point to the first time point falls within a predetermined period. That is, even in a case corresponding to the cases of FIGS. 2 and 5, the repair after the predetermined period has elapsed from the previous repair is not regarded as the re-repair in general. Therefore, it becomes possible to more accurately determine whether each repair is the re-repair by excluding the combination of repairs that exceed the predetermined period.

In the above embodiment, an example in which the re-repair determination is made for the repair of a product of a vehicle or the like has been described. However, the product is not limited to the vehicle or the like. The product may be any product, as long as the content of a defect symptom in each repair or the information of the component part on which the measures have been taken are managed as the repair information. The product may be an engine, a motor, or the like mounted on a vehicle, another moving body, a generator, or the like.

In the above embodiment, an example has been described in which the apparatus 10 includes the information output unit 13, and transmits the repair information to the information input terminal 20 of a store or the like that repairs the products. However, the repair information providing apparatus is not limited to such an apparatus. For example, only the re-repair determination and the update of the repair information may be automatically made, and the updated repair information may be output in accordance with an output command from the outside. That is, a person who receives the repair information may access the apparatus 10 as necessary to acquire the updated repair information.

In the above embodiment, an example in which the re-repair determination is automatically made whenever new repair information is acquired has been described with reference to FIG. 7 and the like. However, the re-repair determination unit that makes the re-repair determination is not limited to such an example. In response to a command from the outside, for example, the repair information of a series of repairs that have been carried out on each product may be extracted from the repair information stored and accumulated in the information storage unit 14, and the re-repair determination may be made. That is, the re-repair determination may be made in response to a request from a person who receives provision of the repair information.

Heretofore, the present invention has been described as the repair information providing apparatus. However, the present invention is also usable as a repair information providing method. That is, the repair information providing method to be performed on a computer includes: an information acquisition step S1 of acquiring repair information regarding repairs of a product; and re-repair determination steps S2 to S12 of determining, based on the repair information acquired in the information acquisition step S1, whether the repair carried out on the product at the first time point is a re-repair for eliminating a defect of the product that has not been eliminated by the repair carried out at the second time point, which is before the first time point (FIG. 6). The repair information includes, for every repair of the product, occurrence information of the defect of the product and information of a component part that has been repaired (FIG. 7). In the re-repair determination step, in a case where a first target component part repaired at the first time point and a second target component part repaired at the second time point coincide with each other, or in a case where the defect content identified by the occurrence information of the defect of the first target component part and the defect content identified by the defect occurrence information of the second target component part coincide with each other, it is determined that the repair carried out at the first time point is the re-repair (FIGS. 2 and 5).

The above embodiment can be combined as desired with one or more of the aforesaid modifications. The modifications can also be combined with one another.

According to the present invention, it becomes possible to accurately determine whether each repair is a re-repair.

Above, while the present invention has been described with reference to the preferred embodiments thereof, it will be understood, by those skilled in the art, that various changes and modifications may be made thereto without departing from the scope of the appended claims.

1. A repair information providing apparatus, comprising: a processor and a memory coupled to the processor, wherein
the memory is configured to store repair information regarding repairs of a product, wherein
the processor is configured to perform:
acquiring the repair information; and
determining whether a repair performed on the product at a first time point is a re-repair for eliminating a defect of the product that has not been eliminated by a repair performed on the product at a second time point before the first time point based on the repair information, wherein
the repair information includes occurrence information of the defect and component part information of a repaired component part for every repair of the product, wherein
the processor determines that the repair performed at the first time point is the re-repair when a first target component part repaired at the first time point and a second target component part repaired at the second time point coincide with each other, or when a defect content identified by the occurrence information of the defect in the first target component part and a defect content identified by the occurrence information of the defect in the second target component part coincide with each other.

2. The repair information providing apparatus according to claim 1, wherein
the processor determines that the repair performed at the first time point is the re-repair, on condition that a mounting part of the first target component part and a mounting part of the second target component part in the product coincide with each other, when the defect content identified by the occurrence information of the defect in the first target component part and the defect content identified by the occurrence information of the defect in the second target component part coincide with each other.

3. The repair information providing apparatus according to claim 1, wherein
the processor is further configured to perform:
calculating a score value indicating a degree of possibility that the repair performed at the first time point is the re-repair, wherein
the processor calculates the score value of a case where the first target component part and the second target component part coincide with each other to be higher than the score value of a case where the defect content identified by the occurrence information of the defect in the first target component part and the defect content identified by the occurrence information of the defect in the second target component part coincide with each other.

4. The repair information providing apparatus according to claim 3, wherein
the processor, when determining that a plurality of repairs performed at a plurality of the first time points are re-repairs for the repair carried out at the second time point, identifies a combination of the repair performed at the first time point having the possibility highest among the plurality of repairs and the repair performed at the second time point.

5. The repair information providing apparatus according to claim 3, wherein
the component part information includes first character strings identifying a mounting part of the component part and second character strings identifying the component part, wherein
the processor calculates the score value of a case where the second character strings of the first target component part and the second character strings of the second target component part coincide with each other to be higher than the score value of a case where only the first character strings of the first target component part and the first character strings of the second target component part coincide with each other.

6. The repair information providing apparatus according to claim 1, wherein
a period of time from the second time point to the first time point falls within a predetermined period.

7. A repair information providing method, comprising the steps of:
acquiring the repair information regarding repairs of a product; and
determining whether a repair performed on the product at a first time point is a re-repair for eliminating a defect of the product that has not been eliminated by a repair performed on the product at a second time point before the first time point based on the repair information, wherein
the repair information includes occurrence information of the defect and component part information of a repaired component part for every repair of the product, wherein
the determining includes determining that the repair performed at the first time point is the re-repair when a first target component part repaired at the first time point and a second target component part repaired at the second time point coincide with each other, or when a defect content identified by the occurrence information of the defect in the first target component part and a defect content identified by the occurrence information of the defect in the second target component part coincide with each other.
